(19) United States
(12) Patent Application Publication
(10) Pub. No.: US 2017/0127717 A1
(43) Pub. Date: May 11, 2017

(54) TOBACCO PAPER DISPENSER

(71) Applicant: Kyle Maher, Foley, AL (US)

(72) Inventor: Kyle Maher, Foley, AL (US)

(21) Appl. No.: 14/937,464

(22) Filed: Nov. 10, 2015

(51) Int. Cl. A24C 5/00; A24F 17/00; A24D 1/02; B29C 45/00

(52) U.S. Cl. CPC A24C 5/002; B29C 45/006; A24F 17/00; A24D 1/022; B29L 2031/7416

(57) ABSTRACT

A device for storing and dispensing rolling paper for rolling cigars or similar smoking articles is provided. The device includes a tube having a slit along the length of the tube, a cap for capping an open end of the tube, and a sheath for enclosing the tube. A roll of rolling paper is stored within the tube and dispensed through the slit in the tube. The paper can be torn to roll a cigar of any desired length. The cap is removable for replacing the roll of paper when it has been completely used. The sheath is used to seal the paper within the interior of the tube when the dispenser is not being used. When sealed, rolling paper containing tobacco will not lose its moisture content, which prevents the paper from becoming brittle between uses.

### FIELD OF THE INVENTION

A preferred embodiment of the present invention refers to a device for dispensing rolling paper.

### BACKGROUND

In recent years it has become increasingly popular for smokers to roll their own cigarettes, cigars, or similar smoking articles instead of buying pre-rolled smoking articles. Loose tobacco, as well as a variety of different types of rolling papers, are readily available to consumers for this purpose. When rolling cigars, in particular, the rolling paper used typically contains some form of tobacco product. In some instances, smokers may simply use cured leaves of the tobacco plant to roll a cigar. In other cases, smokers commonly use a type of manufactured rolling paper made from homogenized tobacco leaf, which comprises processed tobacco pulp. This type of rolling paper, or any similar type of rolling paper comprising some form of tobacco product, is commonly referred to as “tobacco paper” or as a “blunt wrap.” Blunt wraps are typically sold as individual wraps contained in resealable bags. Because the individual blunt wraps are pre-cut to specific sizes, a user cannot easily adjust the size of a user-rolled cigar as desired. Accordingly, a need exists in the art for a dispenser that can be used to easily size blunt wraps for rolling customized cigars of various sizes as desired by the user.

A variety of devices are known in the art for dispensing various kinds of paper, which can be cut into different sizes by the user. However, there are problems with utilizing known paper dispensers for dispensing and sizing rolling papers containing tobacco products. Blunt wraps are typically sold in resealable bags so that unused wraps can be sealed in the original packing for storage for later use. Because blunt wraps contain tobacco products, a certain amount of moisture must be maintained in the wrap to prevent it from drying out. If a blunt wrap becomes too dry, it will become brittle. Brittle papers are generally unsuitable for rolling cigars because they tend to crack and break easily when rolled. Storing the wraps in a sealed container prevents the moisture in the wraps from evaporating and thus keeps the wraps pliable for later use. However, known paper dispensers are generally not designed to prevent paper from losing moisture content to evaporation. Thus, tobacco paper utilized with a conventional paper dispenser would result in a substantial loss of moisture content from the paper. Accordingly, conventional paper dispensers are unsuitable for use with any type of rolling paper containing tobacco products.

Clearly, a need exists in the art for a device for dispensing rolling paper containing tobacco. Furthermore, a need exists in the art for a device for dispensing rolling paper that can be used to roll customized cigars of various sizes.

### SUMMARY

A preferred embodiment of the invention is directed to a device for dispensing rolling paper containing tobacco. The device comprises a tube having an open end and a closed end, a cap configured for capping the open end of the tube, and a sheath for enclosing the tube. The device is utilized with a roll of cigar rolling paper long enough to roll two or more cigars or similar smoking articles. The rolling paper preferably contains tobacco products. The tube has a slit in its side wall that extends along the length of the tube from the open end of the tube to a point substantially near the closed end of the tube. The slit is wide enough to feed an edge of the rolling paper through the slit. In a preferred embodiment, at least one side of the slit has a serrated edge for tearing the paper cleanly. The sheath is compatible with the cap such that the sheath can be connected to the cap to seal the tube within the sheath.

To use the dispenser, the user first installs the roll of paper in the tube by inserting it into the open end of the tube. The end of the paper is fed through the slit such that a portion of the end of the roll of paper extends outside of the tube. The cap is then installed on the tube to cap the open end of the tube to form an enclosure from which the rolling paper is dispensed. The user pulls the end of the paper extending outside the tube until the desired length is obtained. The user then tears the paper along the serrated edge to form an individual rolling paper of a desired size. Once the user has torn off the rolling paper, he may then insert the tube into the sheath and connect the sheath to the cap until the user wishes to tear off another piece of rolling paper. When the sheath is connected to the cap, the tube is sealed within the sheath such that the roll of paper remaining inside the tube will substantially retain its moisture content. Thus, the device is used not only for dispensing rolling paper but also for storing rolling paper that contains tobacco so that the paper will not dry out and become brittle.

Accordingly, one object of the present invention is to provide a device for storing and dispensing rolling paper.

Another object of the present invention is to provide a device for cutting rolling paper to a desired size for rolling customized smoking articles of various sizes.

Another object of the present invention is to provide a device for storing and dispensing rolling paper containing tobacco.

Another object of the present invention is to provide a device for storing and dispensing rolling paper that is portable.

Another object of the present invention is to provide a device for storing and dispensing rolling paper that utilizes a roll of tobacco paper for rolling a plurality of smoking articles such that the device is cost effective to users by using replacement rolls of tobacco paper.

Furthermore, an object of the present invention is to provide a method of using such a device and a method of manufacturing such a device.

### DESCRIPTION OF THE DRAWINGS

These and other features, aspects, and advantages of the present invention will become better understood with regard to the following description, appended claims, and accompanying drawings where:

FIG. 1 depicts a side elevational view of an apparatus embodying features of the present invention.

FIG. 2 depicts a perspective view of an apparatus embodying features of the present invention.

FIG. 3 depicts a side elevational view of an apparatus embodying features of the present invention.

FIG. 4A depicts a side elevational view of an apparatus embodying features of the present invention.

FIG. 4B depicts a side elevational view of an apparatus embodying features of the present invention.

FIG. 4C depicts a side elevational view of an apparatus embodying features of the present invention.

FIG. 5 depicts a perspective view of an alternative embodiment of an apparatus embodying features of the present invention.

### DETAILED DESCRIPTION

In the Summary above and in this Detailed Description, and the claims below, and in the accompanying drawings, reference is made to particular features, including method steps, of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with/or in the context of other particular aspects of the embodiments of the invention, and in the invention generally.

The term “comprises” and grammatical equivalents thereof are used herein to mean that other components, ingredients, steps, etc. are optionally present. For example, an article “comprising” components A, B, and C can contain only components A, B, and C, or can contain not only components A, B, and C, but also one or more other components.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

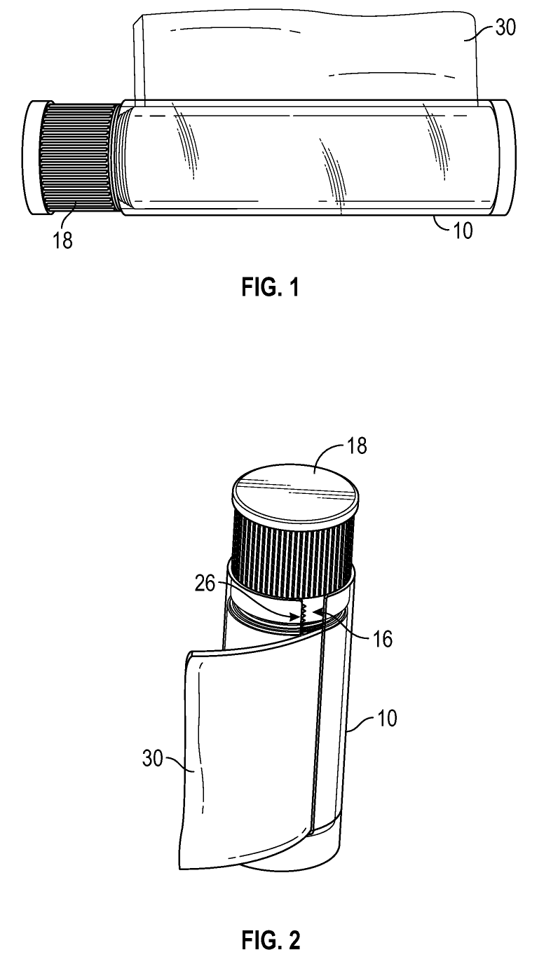

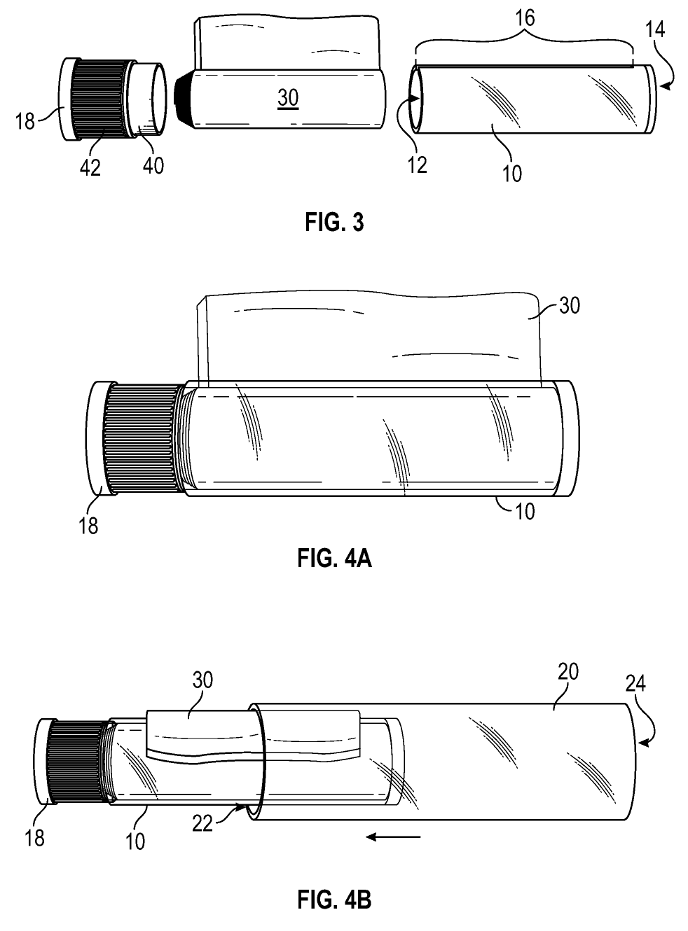

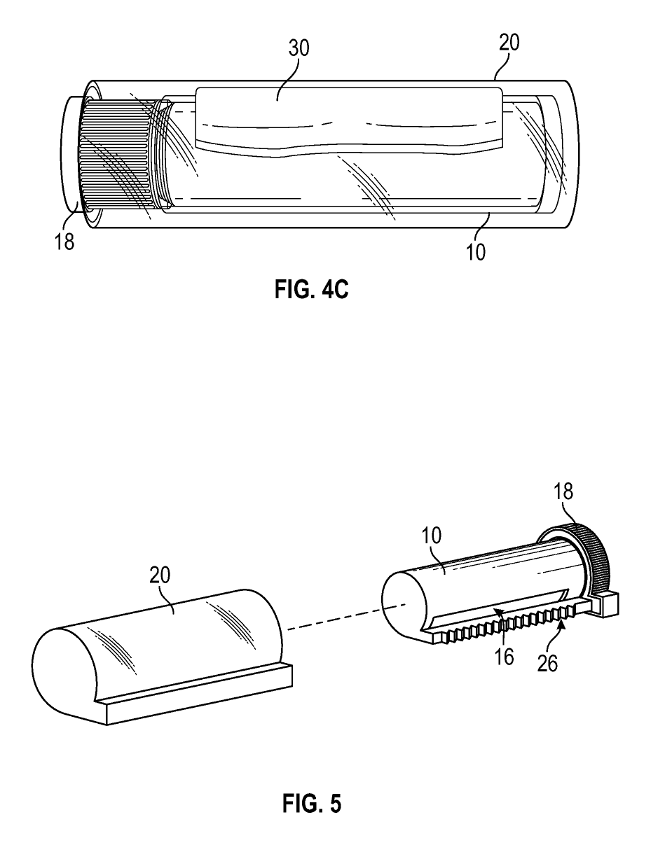

Turning now to the drawings, FIGS. 1-4 illustrate preferred embodiments of the present invention. In one aspect, the present invention comprises a device for storing and dispensing rolling papers for use in rolling cigars or any similar smoking article. As illustrated in FIGS. 3 and 4B, the dispenser of the present invention comprises a tube 10 having an open end 12 and a closed end 14, a cap 18 configured for capping the open end 12 of the tube 10, and a sheath 20 for enclosing the tube 10. As shown in FIGS. 1-3, the present invention may further comprise a replaceable roll of cigar rolling paper 30 long enough to roll two or more cigars or similar smoking articles. The tube 10 has a slit 16 in its side wall extending along at least a portion of the length of the tube 10 for feeding the rolling paper 30 therethrough, as shown in FIG. 2. Preferably, at least one side of the slit 16 has a serrated edge 26 for tearing the paper cleanly. The sheath 20 is compatible with the cap 18 such that the sheath 20 can be connected to the cap 18 to seal the tube 10 within the sheath 20.

The rolling paper dispenser of the present invention is advantageous because it allows a user to tear off a desired length of rolling paper 30 for rolling customized smoking articles of various sizes, as desired by the user. The dispenser of the present invention is particularly advantageous when used in conjunction with rolling papers comprising tobacco. Because the moisture content of rolling papers containing tobacco must be maintained at certain levels to prevent the paper from drying out and becoming brittle, papers containing tobacco should be stored in an airtight container to prevent the moisture from evaporating. As shown in FIGS. 4B-4C, the dispenser of the present invention comprises a sheath 20 that can be used to seal the rolling papers 30 within the tube 10 to substantially reduce any moisture loss. Thus, a roll of paper 30 containing tobacco can be stored inside the tube 10 between uses without drying out the paper. As used herein, tobacco refers to any part of the tobacco plant or by-products of tobacco production, which may include leaves or stems of the plant. Rolling papers containing tobacco are commonly referred to as, and herein will be referred to as, “tobacco paper,” “cigar paper,” “cigar wraps,” or “blunt wraps.”

Furthermore, the dispenser of the present invention is cost effective compared to alternatives that are currently commercially available to consumers. Currently, blunt wraps are typically sold to consumers in packs containing individual blunt wraps. Each wrap is sized to roll a single cigar or similar smoking article. The dispenser of the present invention is utilized with a roll of tobacco paper 30 long enough to roll a plurality of cigars. Thus, because the present invention allows a user to utilize a replaceable roll of tobacco paper 30, the user can purchase tobacco paper in bulk, thereby providing a cost savings compared to purchasing individual blunt wraps.

FIGS. 1-2 show a preferred embodiment of the present invention with a roll of rolling papers 30 installed within the tube 10 and the cap 18 installed on the open end 12 of the tube 10. FIG. 3 shows a preferred embodiment before the cap 18 and the roll of paper 30 have been installed. The tube 10 is preferably cylindrical in shape, through other shapes, such as a tube having a polygonal outer shape, could be utilized. The tube 10 is preferably made of a hard plastic material. Additionally, the tube 10 has a slit 16 in its side wall that extends along at least a portion of the length of the tube 10. The slit 16 forms an edge 26 along the length of each side of the slit 16 in the side wall of the tube 10. As illustrated in FIG. 3, the slit 16 preferably extends from the open end 12 of the tube 10 to a point substantially near the closed end 14 of the tube 10, preferably in a generally straight line. The slit 16 is wide enough to feed an edge of the rolling paper 30 through the slit 16 without the edges of the slit 16 contacting the paper with enough force to cause the paper to tear. Accordingly, the slit 16 should be of sufficient width such that any commercially available rolling paper of a standard thickness may be utilized with the dispenser of the present invention without tearing the paper when feeding the paper through the slit.

In a preferred embodiment, at least one of the edges 26 along the length of each side of the slit 16 is serrated such that rolling paper 30 fed through the slit 16 can be easily torn along the serrated edge 26. In an alternative embodiment, the dispenser further comprises a cutting blade attached to the tube 10 such that the blade is positioned along the length of one side of the slit 16. The blade is preferably serrated to aid in cutting the rolling paper. The blade may be attached to the interior or the exterior of the side wall of the tube 10.

The cap 18 is configured for capping the open end 12 of the tube 10. In a preferred embodiment, as illustrated in FIG. 3, the cap 18 has a generally cylindrical shape and has a lower end 40 and an upper end 42. The upper end 42 has a larger diameter than the lower end 40. The lower end 40 of the cap 18 is sized such that the lower end 40 can be inserted into the open end 12 of the tube 10 to cap the tube. When inserted, the fit between the lower end 40 of the cap 18 and the open end 12 of the tube 10 should be tight enough such that the cap 18 will not fall out if the device is turned upside down. However, the fit should not be so tight that the cap 18 cannot be removed from the tube 10 by hand.

As shown in FIGS. 1-2, the cap 18 is configured such that only the lower end 40 can be inserted into the open end 12 of the tube 10. The upper end 42 of the cap 18, having a larger diameter than the lower end 40, functions as a stopper that prevents the cap 18 from being further inserted into the open end 12 of the tube 10.

In an alternative embodiment (not shown), the cap 18 may be configured such that the lower end 40 fits around the exterior of the tube 10 in order to cap the open end 12 of the tube 10. In this embodiment, the cap 18 has a hollow interior, and a stopping element is preferably located in the interior of the cap 18 to control how far the cap 18 may be pushed down onto the tube 10. Additionally, in this embodiment, the lower end 40 and the upper end 42 of the cap 18 preferably have the same diameter.

As illustrated in FIGS. 4B-4C, the sheath 20 is configured for enclosing the tube 10. In a preferred embodiment, the sheath 20 is made of a rigid material, such as a hard plastic material, and has the same general shape as the tube 10, but is slightly larger than the tube 10 so that the tube 10 fits inside the sheath 20. As shown in FIG. 4C, the sheath 20 has an open end 22 and a closed end 24. The open end 22 of the sheath 20 is compatible with the cap 18 such that the sheath 20 and the cap 18 can be connected to each other to seal the tube 10 within the sheath 20. In a preferred embodiment, the cap 18 is configured such that the upper end 42 of the cap 18 can be inserted into the open end 22 of the sheath 20 in order to connect the sheath 20 to the cap 18, as shown in FIG. 4C. When the sheath 20 and cap 18 are connected, the fit between the upper end 42 of the cap 18 and the open end 22 of the sheath 20 should be tight enough such that a roll of paper 30 located inside the tube 10, which is enclosed within the sheath 20, will substantially retain its moisture content. However, the fit should not be so tight that the sheath 20 cannot be removed from the cap 18 and the tube 10 by hand.

The dispenser of the present invention may be sold with or without a roll of rolling papers 30. In either case, compatible rolls of paper 30 will be sold separately from the dispenser as replacement rolls. In a preferred embodiment, each roll of rolling paper 30 is approximately 2 to 4 inches wide, and in a more preferred embodiment, approximately 2.5 to 3 inches wide. In addition, each roll 30 is preferably about 2 to about 4 feet long such that each roll 30 may be used to roll a plurality of cigars or similar smoking articles. Each roll 30 is configured to fit within the interior of the tube 10. Accordingly, each roll 30 should have a diameter that is smaller than the interior diameter of the tube 10. In addition, each roll 30 should have a width such that the roll 30 fits within the interior of the tube 10 between the closed end 14 of the tube 10 and the lower end 40 of the cap 18 when the lower end 40 of the cap 18 is fully inserted into the open end 12 of the tube 10. Furthermore, the slit 16 in the side wall of the tube 10 should be of sufficient length such that the entire width of a roll of paper 30 can be fed through the slit 16 when the lower end 40 of the cap 18 is fully inserted into the open end 12 of the tube 10, as shown in FIG. 2.

To use the dispenser of the present invention, a user first installs a fresh roll of paper 30 in the tube 10 by inserting the roll 30 into the open end 12 of the tube 10. The end of the paper is fed through the slit 16 such that a portion of the end of the roll of paper 30 extends outside of the tube 10, as shown in FIG. 2. Because the slit 16 extends all the way to the open end 12 of the tube 10, the user can feed the side edge of the roll of paper near the end of the paper into the slit 16 at the open end 12 of the tube 10 as the user inserts the roll 30 into the open end 12 of the tube 10. The user then installs the cap 18 on the open end 12 of the tube 10 to cap the open end 12 of the tube 10 to form an enclosure from which the rolling paper 30 is dispensed from the interior of the tube 10 through the slit 16. The cap 18 is preferably installed by inserting the lower end 40 of the cap 18 into the open end 12 of the tube 10. The user then pulls the end of the paper 30 extending outside the tube 10 until the desired length is obtained. The user tears the paper 30 along the serrated edge 26 to form an individual rolling paper of a desired length. Once the user has torn off the rolling paper, the user then inserts the tube 10 into the sheath 20 and connects the sheath 20 to the cap 18 to seal the roll of paper 30 within the interior of the tube 10 for later use. FIG. 4B shows a tube 10 being inserted into a sheath 20, and FIG. 4C shows a tube 10 fully inserted into a sheath 20. The sheath 20 is preferably connected to the cap 18 by inserting the upper end 42 of the cap 18 into the open end 22 of the sheath 20, as shown in FIG. 4C. When sealed, a roll of tobacco paper 30 stored within the tube 10 will substantially retain its moisture content. Thus, the device is used not only for dispensing rolling papers but also for storing any type of rolling paper containing tobacco so that the paper will not dry out and become brittle. The moisture content in the tobacco paper is preferably maintained at a level of at least about 10% by weight, and more preferably at a level of at least about 12% by weight.

In a preferred embodiment, the sheath 20 is sized such that a small space remains between the interior of the sheath 20 and the exterior of the tube 10 when the tube 10 is enclosed within the sheath 20. The space is preferably large enough such that the end of the roll of paper 30 located outside the tube 10 can remain outside the tube 10 when the tube 10 is enclosed within the sheath 20, i.e., the between the interior of the sheath 20 and the exterior of the tube 10, as shown in FIG. 4C. Thus, when the user is ready to dispense another length of paper, the user does not have to re-feed the paper through the slit 16 in the side wall of the tube 10. When the sheath 20 is properly connected to the cap 18, the paper located between the interior of the sheath 20 and the exterior of the tube 10 will be sealed within the sheath 20 and will retain its moisture content.

The tube 10, the cap 18, and the sheath 20 are all preferably made of hard plastic, such as ABS (acrylonitrile butadiene styrene) plastic, but may be made of any suitable material known in the art, including, but not limited to, glass, metal, rubber, or any combination thereof. To manufacture the device of the present invention, the tube 10, the cap 18, and the sheath 20 are all preferably produced through injection molding, though these components may be produced by any other suitable method known in the art. Once these individual components have been produced, the cap 18 may then be installed on the open end 12 of the tube, preferably by inserting the lower end 40 of the cap 18 into the open end 12 of the tube 10 until the open end 12 of the tube 10 is directly adjacent to the upper end 42 of the cap 18. The sheath 20 may then be installed around the tube 10 by inserting the closed end 14 of the tube 10 into the sheath 20 and then connecting the sheath 20 to the cap 18, preferably by inserting the upper end 42 of the cap 18 into the open end 22 of the sheath 20. This step seals the tube 10 and its contents within the sheath 20.

The dispenser may be sold with one or more rolls of tobacco paper 30 or similar rolling paper. In a preferred embodiment, a roll of paper 30 is installed within the tube 10 by inserting the roll 30 into the open end 12 of the tube 10 before the cap 18 and the sheath 20 are installed to seal the tube 10. To produce the roll of paper 30 utilized with the present invention, sheets of tobacco paper are first produced utilizing any suitable method known in the art. The sheets are then cut into sections that are preferably approximately 2 to 4 inches wide, and in a more preferred embodiment, approximately 2.5 to 3 inches wide, and preferably about 2 to about 4 feet long such that each roll 30 may be used to roll a plurality of cigars or similar smoking articles. Alternatively, the roll 30 may be longer than 4 feet in length as long as the roll fits inside the tube 10 with sufficient annular space to allow the roll 30 to rotate within the tube 10 as the paper is dispensed through the slit 16 in the side wall of the tube 10. Thus, the diameter of the tube 10 may be adjusted to accommodate larger rolls of paper 30 for rolling an increased number of cigars or similar smoking articles.

As discussed previously, at least one of the edges 26 along the length of each side of the slit 16 is preferably serrated such that rolling paper 30 fed through the slit 16 can be easily torn along the serrated edge 26. The tube 10 is preferably injection molded to produce a serrated edge 26 on one or both sides of the slit 16. In an alternative embodiment that comprises a cutting blade for tearing the rolling paper 30, the cutting blade is preferably a relatively thin strip of metal having a serrated edge. The blade is attached to the tube preferably by a glue or adhesive applied to one side of the blade and/or the side wall of the tube 10. The blade is preferably attached to the interior of the side wall of the tube, but may alternatively be attached to the exterior of the side wall of the tube. The blade is positioned along a length of one side of the slit 16 in the side wall of the tube 10 such that the serrated edge can be used to cleanly tear the rolling paper as it is dispensed. Thus, the blade should extend from a point approximately adjacent to the lower end 40 of the cap 18 (when the lower end 40 is fully inserted into the open end 12 of the tube 10) to the opposite end of the slit 16, which is substantially near the closed end 14 of the tube 10.

FIG. 5 shows an alternative embodiment of the present invention with a tube 10 and a cap 18 each having a modified shape. In this embodiment, the serrated edge 26 extends away from the exterior of the tube 10. This small extension may make it easier for the user to tear off a length of rolling paper without causing the end of the roll of paper to contract such that the entire roll is within the tube 10 after tearing off a length of paper. Thus, in this embodiment, it may be easier to keep a short length at the end of the roll of paper on the exterior of the tube 10 for the next use. As shown in FIG. 5, the cap 18 and the sheath 20 have a shape corresponding to the shape of the tube 10 such that the cap 18 can be used to cap the open end of the tube and the tube can be inserted into the sheath 20 to seal the interior of the tube as previously discussed.

It is understood that versions of the invention may come in different forms and embodiments. Additionally, it is understood that one of skill in the art would appreciate these various forms and embodiments as falling within the scope of the invention as disclosed herein.

What is claimed is:

1. An apparatus for storing and dispensing rolling paper, said apparatus comprising:
a. a tube having an open end and a closed end, said tube having a slit in the side wall of the tube, said slit extending longitudinally along the side wall of the tube from the open end to a point substantially near the closed end;
b. a cap configured for capping the open end of the tube; and
c. a sheath configured for enclosing the tube, said sheath having an open end and a closed end, said open end being compatible with said cap such that the sheath and the cap can be connected to seal the tube within the sheath.

2. The apparatus of claim 1, wherein said slit is of a sufficient width such that an edge of a roll of paper can be fed through the slit without tearing the paper.

3. The apparatus of claim 2, further comprising a roll of paper configured to fit within the interior of the tube with the cap installed on the open end of the tube.

4. The apparatus of claim 3, wherein the paper comprises tobacco.

5. The apparatus of claim 1, wherein at least one side of said slit has a serrated edge.

6. The apparatus of claim 1, wherein said tube is cylindrical.

7. The apparatus of claim 1, wherein said sheath is cylindrical.

8. A method of manufacturing an apparatus for storing and dispensing rolling paper, said method comprising the steps:
a. producing a tube by injection molding, said tube having an open end and a closed end, said tube having a slit in the side wall of the tube, said slit extending longitudinally along the side wall of the tube from the open end to a point substantially near the closed end;
b. producing a cap by injection molding, said cap configured for capping the open end of the tube; and
c. producing a sheath by injection molding, said sheath configured for enclosing the tube, said sheath having an open end and a closed end, said open end being compatible with said cap such that the sheath and the cap can be connected to seal the tube within the sheath;

9. The method of claim 8, wherein said slit is of a sufficient width such that an edge of a roll of paper can be fed through the slit without tearing the paper.

10. The method of claim 9, further comprising the step of installing a roll of paper within the interior of the tube.

11. The method of claim 10, wherein said paper comprises tobacco.

12. The method of claim 10, further comprising the steps of installing the cap on the open end of the tube, and then sealing the tube within the sheath by installing the sheath around the tube and connecting the sheath to the cap.

13. The method of claim 8, wherein at least one side of said slit has a serrated edge.

14. The method of claim 8, wherein said tube is cylindrical.

15. The method of claim 8, wherein said sheath is cylindrical.

16. The method of claim 8, further comprising the steps of installing the cap on the open end of the tube, and then sealing the tube within the sheath by installing the sheath around the tube and connecting the sheath to the cap.
